(19) United States
(12) Patent Application Publication
(10) Pub. No.: US 2011/0103565 A1
(43) Pub. Date: May 5, 2011

(54) System and method for service resolution

(76) Inventors: Bizhan Karimi-Cherkandi, Boca Raton, FL (US); Farrokh Mohammadzadeh Kouchri, Boca Raton, FL (US)

(21) Appl. No.: 11/666,818

(22) PCT Filed: Aug. 3, 2005
(86) PCT No.: PCT/EP05/53790

§ 371 Date: Sep. 3, 2008

Related U.S. Application Data
(60) Provisional application No. 60/624,729, filed on Nov. 3, 2004.

(51) Int. Cl. H04M 3/42

(52) U.S. Cl. 379/201.04; 379/201.02

(57) ABSTRACT

Providing service resolution between a calling subscriber and a called subscriber of a telecommunications network, wherein a call of a calling subscriber device of the calling subscriber includes content for at least a first capability and a second capability and called subscriber device is capable of only a subset of the first and second capabilities. The calling subscriber device requests a call with the first and second capabilities. The called subscriber device broadcasts a signal to at least one peripheral device and requests a response from devices that are capable of the subset capability. A peripheral device responds that it has the requested subset capability. The called subscriber device splits the media received and sends the media corresponding to the requested subset capability to the peripheral device for processing.

An incoming call for an end point addresses capabilities that the end point may fulfill. If an end point does not possess the capability, the call may be rejected, or some aspects of the call, specific to that capability shall not be processed and negotiated.

The multiple capabilities addressed in a call may be present in different entities, but not accessible from one particular entity. For example, a voice only device, may receive a call with voice plus video. However, there may be a device such as intelligent-TV in the periphery that may fulfill some aspect of the call but not all. On the other hand, such a intelligent-TV is not equipped with a microphone and handset. Still further, the phone lacking the graphic display can also not fulfill all aspects of the call.

Another example is when an incoming call requires a certain codec (e.g. G729x), where at the terminating side, the phone lacks the corresponding codec, but the existing PC in the network is capable of the required codec.

Currently, multiple calls are used to connect to multiple devices when the incoming call requires multiple capabilities. For example, an A-side user may create a voice call from his PC to a user-B's phone and create a video call from the same PC to user-B's PC to provide voice and video at the same time. These are two separated calls.

Another manner in which multiple call capabilities were handled was that, when the incoming call requested multiple capabilities, the capabilities had to be negotiated down. For example, the end point would negotiate which capabilities could be left out and still be acceptable by the calling party. In other instances, certain capabilities could be substituted for others.

Currently, it would be better to have a device that has all possible capabilities that the user or his call partner may wish to use in a call.

### SUMMARY OF THE INVENTION

Providing service resolution between a calling subscriber A and a called subscriber B of a telecommunications network, wherein a call of a calling subscriber device A of the calling subscriber A includes content for at least capabilities C1 and C2 and called subscriber device B is capable of only a subset of the capabilities C1 and C2. The calling subscriber device A requests a call with the capabilities C1 and C2. The called subscriber device B broadcasts a signal to at least one peripheral device and requests a response from devices that are capable of the subset capability. A peripheral device responds that it has the requested subset capability. The called subscriber device B splits the media received and sends the media corresponding to the requested subset capability to the peripheral device for processing.

### BRIEF DESCRIPTION OF THE DRAWINGS

FIG. 1A illustrates the invention, and

FIG. 1B illustrates a variant of the invention.

### DETAILED DESCRIPTION

In general, the invention provides a method for addressing the multiple capability request of an incoming call.

First, a call is initiated from a device A, with capabilities c1, c2, . . . , cn, for example, and terminates to an intelligent device B.

The device B is incapable of, for example, capability c2. Thus, the device B attempts to share the capability c2 of another device to handle the call using following methodology.

In the invention a send service resolution protocol, i.e. broadcast request, is sent to all devices in the periphery. Essentially, the request asks “who has the capability c2?”.

Then, the invention awaits for a response. This may be done using a supervising response mechanism, such as a timer.

Optionally, a display displays the existing list of devices capable of c2 to the user to choose from. Once the user has made a choice (device C), the enhanced capability (c1, c2 . . . cn) shall be indicated to the originating call-partner (device A).

To continue, upon call-acceptance, the media streams are split into streams S1 (referring to c1, . . . cn) and S2 (referring to c2) streams. However, this is not the same as separated calls.

The media-stream part (S1) that can be handled by the device B, is processed. The media-stream part (S2) that cannot be handled by the device, is processed by device C.

Next, the signaling supporting the S2 stream between devices B and C, is handled strictly between B and C. Device A has not notice of the involvement of C. In other words, the process is transparent to device A.

A potential application for the invention is to translate capability. For example, an incoming call may require a certain capability (e.g. codec) to be applied for the media. The device the user may wish to use to accept the call, may have no such capability (e.g. codec). In this case, the device sends an SRP to locate another network-entity, which can translate (transcode). If one or more entities respond to this SRP, then the device can now offer this capability to the caller.

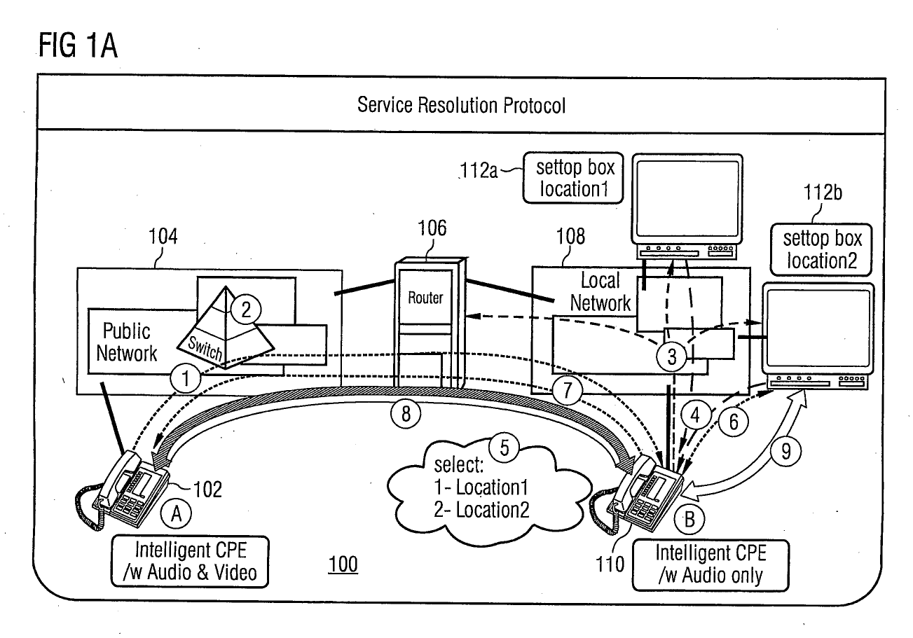

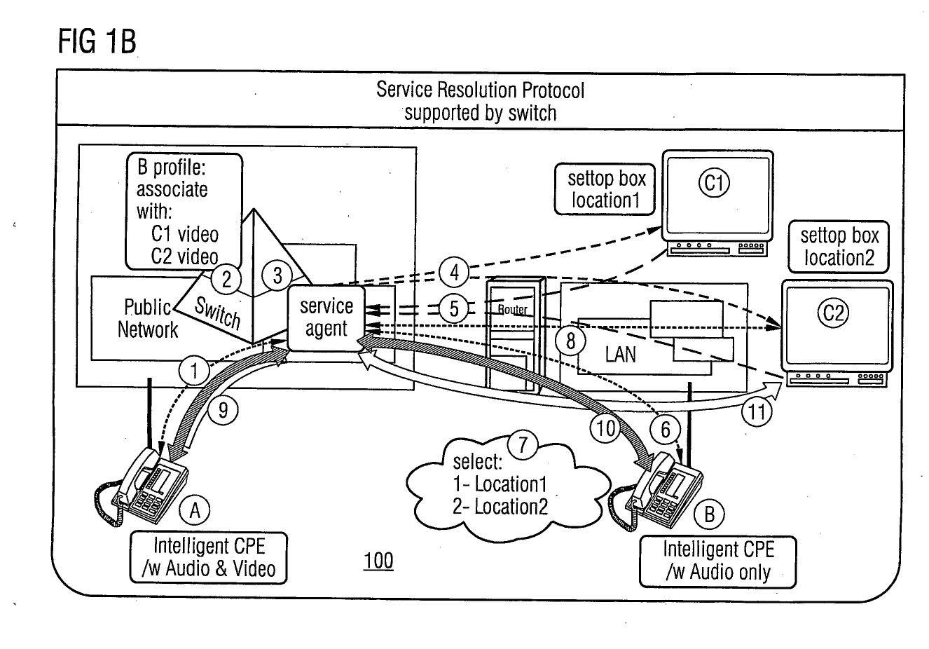

FIG. 1A illustrates the service resolution protocol 100.

The device A 102, shown here as CPE A, requests a call with video & audio. This is generally indicated by signal path (1).

A public network 104, which may contain a Telco switch, routes the call to a subscriber behind the router 106 (shown as CPE B). This is indicated generally by signal path (2).

A local network 108 receives the call request. The device B 110, here CPE-B, in this example, does not have video capability, for example, and hence broadcasts a “service resolution protocol” in the local network as indicated by signal (3).

All devices, or a subset thereof, with requested capability (video) respond. This may be, for example devices 112a or 112b, etc., which are shown here to be television or displays controlled by respective set top boxes (STB). This is indicated here generally by signal (4).

The user, not shown, is alerted and the devices with the desired capability are displayed for selection. This optional feature is indicated generally by reference (5). In the alternative, the invention may select the device automatically for the user.

After the user has selected the device (implicitly accepting the call), the device B 110 opens a signaling to reserve the resource for video stream. This is indicated in the figure as signal (6). Here, device 112b was selected, although any device may be selected.

Next, the device B 110 acknowledges the request from device A 102 for the requested capabilities. This is indicated generally by signal (7).

Once the connection is established and the devices selected, the device A 102 starts the media stream over the media channel to device B 110. This is indicated generally by signals (8).

Now, device B 110 splits the media received. In this example, the audio and video are split and processed by the different devices. In this case, the audio is processed by device B 110 and the video is processed by device 112b. This is generally indicated by signal 9.

FIG. 1B illustrates a variant on the above. Here, a central entity in the network, manages the available resources in the network. The device A requests a call with video & audio, as shown generally by signal (1).

Signal (2) illustrates that the public network finds the route to sub B and since sub B's profile indicates “no support for video”, it activates a service agent. A signal (3) indicates that the service Agent is activated

The service Agent initiates SARP to all devices resolved from B's profile analysis (C1 & C2). This is indicated generally by signal (4).

As indicated generally by (5), devices 112a, 112b (shown here as C1 & C2) reserve resources (video) and send an acknowledgement signal.

The Service agent informs device B of an incoming call, with the option of devices 112a, b (C1 or C2) as a complementary video service. This is indicated generally by reference (6).

The user optionally selects devices 112a, b (C1 or C2) (or none) and accepts the call toward service agent. This is indicated generally by reference signal (7).

The selected device (here, 112b C2) is signaled to participate in the active call as illustrated by signal (8). Device 112a (C1) is released from this call (not shown).

Then the device 102 (CPE-A) starts video audio streaming as indicated by signals (9).

The service agent splits the audio to device B 110 (CPE-B), as indicated by signal (10), and the video to device 112b (C2) as indicated by signal (11).

This invention provides a method and apparatus for sharing the resources and capabilities that are spread in various devices. Using this methodology, all available capabilities “in multiple entities” can be presented as “in one entity”.

The need to establish separated calls to address different capabilities in different devices is, thus, obsolete.

This method can be realized using a new standard protocol controlled by the concerned device (presented in example 1 CPE-B).

1-9. (canceled)

10. A method for providing service resolution between a calling subscriber and a called subscriber of a telecommunications network, wherein a call of a calling subscriber device of the calling subscriber includes content for at least a first capability and a second capability and called subscriber device is capable of only a subset of the first and second capabilities, comprising the steps of:
broadcasting a signal by the called subscriber device to at least one peripheral device, the signal requesting a response from devices that are capable of the subset capability;
responding of a peripheral device that has the requested subset capability;
splitting media received by the called subscriber device; and
sending by the called subscriber device the media corresponding to the requested subset capability to the peripheral device for processing.

11. The method according to claim 10, further comprising the step of routing the call to the called subscriber device.

12. The method according to claim 10, further comprising the step of receiving the call request.

13. The method according to claim 10, further comprising the step of alerting the called subscriber device to the peripheral device with the desired capability.

14. The method according to claim 10, further comprising the step of displaying the peripheral device for selection.

15. The method according to claim 10, further comprising the step of the peripheral device opening a signaling to reserve the resource for video stream.

16. The method according to claim 10, further comprising the step of acknowledging the request from the calling subscriber device for the requested capability.

17. The method according to claim 10, further comprising the step of starting a media stream over a media channel from the calling subscriber device to the called subscriber device.

18. A system for providing service resolution between a calling subscriber and a called subscriber of a telecommunications network,
a calling subscriber device;
a called subscriber device;
a call with a first capability and a second capability that is request by the calling subscriber device to a the called subscriber device, wherein the called subscriber device is capable of only a subset of the first and second capabilities;
a message that is broadcasted by the called subscriber device to at least one peripheral device, the message requesting a response from devices that are capable of the subset capability; and
a peripheral device that has the requested subset capability responds to the broadcasted message;
wherein the media received by the called subscriber device is split, and
wherein the called subscriber device sends the media corresponding to the requested subset capability to the peripheral device for processing.

19. The system according to claim 18, wherein the call is routed to the called subscriber device.

20. The system according to claim 19, wherein the call request is received.

21. The system according to claim 20, wherein the called subscriber device is alerted to the peripheral device with the desired capability.

22. The system according to claim 21, wherein the peripheral device is displayed for selection.

23. The system according to claim 18, wherein the peripheral device opens a signaling to reserve the resource for video stream.

24. The system according to claim 18, wherein the request from the calling subscriber device is acknowledged for the requested capability.

25. The system according to claim 18, wherein a media stream over a media channel is started from the calling subscriber device to the called subscriber device.
